(19) United States
(12) Patent Application Publication
(10) Pub. No.: US 2024/0336866 A1
(43) Pub. Date: Oct. 10, 2024

(54) AQUEOUS LUBRICANT COMPOSITION FOR METALWORKING

(71) Applicant: TOTALENERGIES ONETECH, COURBEVOIE (FR)

(72) Inventor: Richard FRELECHOUX, SOLAIZE (FR)

(21) Appl. No.: 18/575,562

(22) PCT Filed: Jun. 30, 2022
(86) PCT No.: PCT/EP2022/068173

§ 371 Date: Dec. 29, 2023

(30) Foreign Application Priority Data
Jul. 1, 2021 (FR) FR2107132

(51) Int. Cl. C10M 173/00; B23Q 11/10; C10M 133/08; C10M 135/02; C10M 141/08; C10M 145/28; C10M 145/40; C10M 165/00; C10N 30/06; C10N 40/20

(52) U.S. Cl. CPC C10M 173/00; B23Q 11/1038; C10M 133/08; C10M 135/02; C10M 141/08; C10M 145/28; C10M 145/40; C10M 165/00; C10M 2201/02; C10M 2209/104; C10M 2209/12; C10M 2215/26; C10M 2219/00; C10N 2030/06; C10N 2040/20

(57) ABSTRACT

The present invention relates to an aqueous lubricating composition comprising at least:
water;
from 0.01% to 10% by weight of at least one polysaccharide;
from 0.1% to 10% by weight of at least one alkoxylated castor oil;
from 0.1% to 10% by weight of at least one sulfur-containing and/or phosphorus-containing antiwear compound.

The invention also relates to the use of the combination of at least one alkoxylated castor oil and of at least one phosphorus-containing and/or sulfur-containing antiwear compound in an aqueous lubricating composition comprising at least one polysaccharide, in order to improve its antiwear and/or extreme-pressure properties.

### TECHNICAL FIELD

The present invention relates to the field of lubricating compositions, and more particularly to lubricating compositions employed in metalworking processes, such as machining operations on metal parts. In particular, the present invention relates to aqueous-based lubricating compositions.

### PRIOR ART

Lubricating compositions, also known as “lubricants”, are commonly employed in mechanical systems to reduce frictional actions between parts and thus to protect them against wear. In addition to wear phenomena, frictional actions can oppose the relative movement of the parts in contact and induce energy losses which are detrimental to optimal functioning of the mechanical system.

Lubricants are used for multiple applications, from the lubrication of combustion vehicle engines to the lubrication of machines employed for machining operations, what is commonly referred to as metalworking, in particular for metal deformation operations.

Metalworking more generally corresponds to the implementation of mechanical or metallurgical processes, both diversified or more specialized, which can be defined as conformation, cutting or jointing processes. This can also concern any mechanical transformation of the metal, such as machining (turning, milling, drilling, sawing, threading, inter alia), forming, cutting, stamping or also rolling.

The operations relating to metalworking require very particularly the employment of lubricating compositions, with the aim of reducing the frictional forces between the metal parts in contact and of preventing their premature wear, while advantageously guaranteeing cooling of these.

These lubricating compositions, dedicated to lubrication in metal machining processes, are also commonly denoted under the names “metalworking compositions or fluids”, “machining lubricants or fluids” or also “cutting lubricants or fluids”.

Conventionally, the lubricating formulations employed for such machining operations are lubricants predominantly composed of one or more base oils, with which additives dedicated to stimulating the lubricating performance qualities of the base oils, such as, for example, friction-modifying additives, are generally combined.

In general, these lubricating formulations are classified from the viewpoint of the type of oil which they incorporate. Thus:
nonrenewable mineral fluids are those comprising mineral oils, such as paraffinic, aromatic or naphthenic oils, in their base formulation;
renewable fluids, of vegetable or animal origin, are those comprising vegetable oils, animal oils or fats in their base formulation;
mineral fluids of synthetic origin are those comprising chemically modified mineral oils or petrochemical derivatives in their base formulation, such as, for example, poly-α-olefins, polyalkylene glycols and hydrogenated mineral oils;
renewable fluids of synthetic origin are those comprising chemically modified vegetable or animal oils in their base formulation, such as, for example, esters of vegetable oils, sulfited, oxidized or esterified vegetable oils, or also sulfated animal oils.

Certain formulations, referred to as mixed formulations, comprise a mixture of the oils listed above in their base formulation. The best known are called semisynthetic oils and correspond to a mixture of synthetic and mineral oils.

However, the use of oils or fats in lubricating compositions for metalworking exhibits several disadvantages. In particular, oil-based lubricants generally exhibit a low resistance to microbial attack, weak cooling properties or also a negative impact on the working environment, health or also safety.

Lubricants in emulsion form, comprising an aqueous phase added to an oily phase, have thus been developed. However, these lubricants exhibit poor stability, due in part to water hardness and/or to salinity.

With the aim of solving the problems related to the employment of oil-based lubricating formulations in metalworking applications, water-based compositions have shown a certain advantage. These formulations usually include water, supplemented by various additives in order to guarantee the tribological properties required for lubricants, especially in terms of reduction in friction and protection of the parts against wear.

Mention may be made, by way of examples, of the documents WO 2009/106359 and WO 2012/163550, which describe aqueous lubricating compositions comprising in particular water and carboxymethyl cellulose salts.

Mention may also be made of the document EP 3 042 946, which provides a metalworking fluid, devoid of oil and emulsifier, comprising between 0.1% and 2% by weight of a polymer of cellulose type.

Finally, the document GB 1 272 100 provides an aqueous lubricant for metalworking comprising (1) a linear polypropylene glycol or an ethylene oxide/propylene oxide copolymer with a molecular weight of between 2000 and 9000 Da and (2) a polyvinylpyrrolidone, a cellulose ether or a triethanolamine phosphate.

For obvious reasons, optimizing the performance qualities of aqueous lubricants for metalworking is an ongoing objective. In particular, it is sought to constantly improve the tribological properties of lubricants, in particular the antiwear and extreme-pressure properties.

### DISCLOSURE OF THE INVENTION

The present invention thus provides a novel aqueous lubricating composition exhibiting improved tribological properties, in particular antiwear and extreme-pressure properties, suited to its use for metalworking.

More particularly, there is described an aqueous lubricating composition, in particular for metalworking, comprising at least:
water, preferably osmosed water;
from 0.001% to 50% by weight of at least one polysaccharide;
from 0.001% to 50% by weight of at least one alkoxylated, in particular ethoxylated, castor oil;
from 0.001% to 50% by weight of at least one sulfur-containing and/or phosphorus-containing antiwear compound,
   the percentages being expressed with respect to the total weight of the composition.

Thus, the present invention relates, according to a first of its aspects, to an aqueous lubricating composition, in particular for metalworking, comprising at least:
water, preferably osmosed water;
from 0.01% to 10% by weight of at least one polysaccharide;
from 0.1% to 10% by weight of at least one alkoxylated, in particular ethoxylated, castor oil;
from 0.1% to 10% by weight of at least one sulfur-containing and/or phosphorus-containing antiwear compound,
   the percentages being expressed with respect to the total weight of the composition.

According to one embodiment, an aqueous lubricating composition according to the invention additionally comprises at least one polyalkylene glycol, in particular as described in the continuation of the text.

Within the meaning of the present invention, the term “aqueous composition” is understood to denote a composition comprising water as base fluid, in other words as predominant solvent. In particular, the water, preferably osmosed, preferably represents at least 50% by weight of the total weight of the lubricating composition.

In the continuation of the text, the term “aqueous lubricating composition” or “aqueous lubricant” will denote a lubricating composition according to the invention.

Within the meaning of the present invention, the term “osmosed water” is understood to denote water which has undergone purification, in particular by a reverse osmosis process, in order to reduce the content of organic and/or mineral compounds, for example to a content of less than 5.0% by weight, preferably of less than 1.0% by weight. In the continuation of the text, the expressions “demineralized water” or also “ultrapure water” will be considered as equivalent to or synonymous with the expression “osmosed water”. In particular, osmosed water can be “deionized water”, in other words water which has undergone a purification in order to reduce the content of ions, such as Ca²⁺ and HCO₃⁻ ions, typically present in water. Preferably, deionized water does not comprise ions.

Contrary to all expectations, the inventors have discovered that the combined use of at least one polysaccharide, of an alkoxylated, in particular ethoxylated, castor oil and of at least one phosphorus-containing and/or sulfur-containing antiwear compound makes it possible to access an aqueous fluid exhibiting excellent tribological properties, in particular under extreme-pressure conditions, suitable for employment as lubricant for metalworking.

In particular, as illustrated in the examples which follow, the inventors have shown that it is possible, by supplementing an aqueous lubricating formulation comprising at least one polysaccharide with the specific combination of at least one sulfur-containing and/or phosphorus-containing antiwear compound and of an alkoxylated, preferably ethoxylated, castor oil, to significantly improve the tribological properties of the aqueous lubricating formulation, especially the antiwear and extreme-pressure properties.

The combination of at least one alkoxylated, in particular ethoxylated, castor oil and of at least one sulfur-containing and/or phosphorus-containing antiwear compound, in an aqueous lubricating composition comprising at least one polysaccharide, unexpectedly exhibits a synergistic effect on the improvement in the antiwear and extreme-pressure properties of the aqueous lubricant.

The aqueous lubricating composition according to the invention thus exhibits improved friction-reducing performance qualities, in particular under extreme-pressure conditions, compared with a composition not comprising alkoxylated castor oil or antiwear compound according to the invention.

The antiwear and extreme-pressure properties can be evaluated by a 4-ball extreme-pressure test, in particular according to the standard ASTM D2783, as described in detail in the examples below. As demonstrated in the examples, an aqueous lubricating composition according to the invention achieves high weld load values, without significant increase in the wear diameter, which testifies to its excellent tribological properties.

The invention thus relates to the use of the combination of at least one alkoxylated, in particular ethoxylated, castor oil and of at least one phosphorus-containing and/or sulfur-containing, in particular sulfur-containing, antiwear compound in an aqueous lubricating composition comprising at least one polysaccharide, in order to improve its antiwear and/or extreme-pressure properties.

Thus, the aqueous compositions according to the invention prove to be particularly advantageous for employment as lubricants for metalworking. They can thus be employed as metalworking fluids, for various applications, as a substitute for the lubricants conventionally employed, in particular hydrocarbon lubricants.

The invention thus relates, according to another of its aspects, to the use of an aqueous lubricating composition according to the invention as lubricant in a metalworking process.

An aqueous composition according to the invention can more particularly be employed as lubricant in any metal machining operation, for example in conformation, cutting or jointing processes or any other transformation of the metal, such as forming, stamping, rolling, and the like.

It can be intended to be employed for the working of varied metals, such as aluminium, steel, galvanized steel or also yellow metals.

The invention also relates to a metalworking process employing, as lubricant, an aqueous lubricating composition according to the invention. Said process comprises in particular a stage of application of an aqueous lubricating composition according to the invention to the surface of at least a portion of the machining tool (or apparatus) and/or of a metal part to be machined.

The lubricating fluid according to the invention advantageously makes it possible to reduce the friction between the machining tool or apparatus and the machined metal part.

The invention thus relates to the use of an aqueous lubricating composition according to the invention for reducing frictional actions during a machining operation on a metal part.

Moreover, advantageously, an aqueous lubricating composition results in a small amount of gummy residues, after its use in the apparatus employed for the machining of metals.

“Gummy residues” are residues which are relatively viscous and insoluble in the aqueous phase, which can appear subsequent to the machining operations. More particularly, once the machining apparatus has stopped, the lubricant, subject to ambient dehydration, is liable to result in the formation of salts which, combined with the polymers present in the lubricant, can form these gummy residues.

The gummy residues adhere to the walls of the equipment and are liable to cause a blockage of the machining tool, generally requiring undesirable maintenance operations on the machine.

Finally, advantageously, a lubricating composition according to the invention, formed predominantly of water, exhibits little toxicological impact, in particular for persons employing this lubricant. Advantageously, even though water is the predominant solvent of an aqueous lubricant according to the invention, the treated surface is properly lubricated.

In addition, the presence of a large proportion of water makes it possible to facilitate the cleaning of metal surfaces and the removal of the lubricant after machining, in particular by simply passing or rinsing with water.

Other characteristics, alternative forms and advantages of an aqueous lubricating composition according to the invention will become clearer on reading the description and the examples which follow, given by way of illustration and without limitation of the invention.

The expressions “of between . . . and . . . ”, “ranging from . . . to . . . ”, “formed of . . . to . . . ” and “varying from . . . to . . . ” should be understood as limits included, unless otherwise mentioned.

In the description and the examples, unless otherwise indicated, the percentages are percentages by weight. The percentages are thus expressed by weight, with respect to the total weight of the composition. The temperature is expressed in degrees Celsius, unless otherwise indicated, and the pressure is atmospheric pressure, unless otherwise indicated.

### DETAILED DESCRIPTION

### Aqueous Composition

As mentioned above, an aqueous lubricating composition according to the invention, also referred to as aqueous lubricant, is a formulation comprising water as predominant solvent. Within the meaning of the invention, the term “predominant solvent” is understood to mean that water is present in a greater amount than any other solvent possibly present in the composition. Preferably, an aqueous lubricating composition according to the invention comprises at least 50% by weight of water, in particular of osmosed water, preferably between 50% and 90% by weight, more preferentially between 60% and 75% by weight, with respect to the total weight of the composition.

By virtue of its role as solvent, water makes it possible to dissolve said polysaccharide(s), the castor oil and the phosphorus-containing and/or sulfur-containing antiwear additive(s), and also any additive optionally present in the composition, in particular chosen from those described in detail in the continuation of the text.

Advantageously, besides its role as solvent, water makes it possible to access a lubricating composition exhibiting good cooling properties, of use in the field of the machining of metals.

According to a particular embodiment, the water employed in an aqueous lubricating composition according to the invention is deionized water or osmosed water.

Advantageously, deionized water does not comprise ions, such as Ca²⁺ and HCO₃⁻ ions, generally present in water, which are responsible for the conduction of electricity in water.

The employment of deionized water is thus particularly advantageous in the context of the use of the aqueous lubricant according to the invention for applications requiring a fluid which conducts little, indeed even no, electricity.

An aqueous lubricating composition according to the invention differs from hydrocarbon lubricants, which comprise a predominant proportion of one or more water-insoluble base oils.

The term “water-insoluble oil” is understood to mean in particular an oil which does not dissolve substantially in water at ambient temperature (at approximately 25° C.). In particular, a water-insoluble oil exhibits a solubility in water of less than 0.2 g/l at ambient temperature. This concerns in particular the lubricating base oils belonging to groups I to V according to the classes defined in the API classification (or their equivalents according to the ATIEL classification) and their mixtures.

Preferably, an aqueous lubricating composition according to the present invention comprises less than 20% by weight of water-insoluble base oil(s), preferably less than 10% by weight, in particular less than 5% by weight, with respect to the total weight of the composition.

Advantageously, an aqueous lubricating composition according to the invention is completely devoid of water-insoluble oil.

### Polysaccharide

As indicated above, an aqueous lubricating composition according to the invention comprises from 0.01% to 10% by weight of at least one polysaccharide.

It is understood that a lubricating composition according to the invention can comprise a single polysaccharide, or a mixture of at least two distinct polysaccharides, in particular as are described below.

In the context of the present invention, the term “polysaccharides” is understood to mean polymers consisting of several monosaccharides bonded together by glycoside bonds. More preferably, the polysaccharides targeted by the invention are celluloses and galactomannans, preferably guars, and also their derivatives.

Preferably, the polysaccharides targeted by the invention have a molar mass of between 10 and 2000 kg/mol, preferably of between 100 and 1000 kg/mol.

The polysaccharide can, for example, be chosen from cellulose or one of its derivatives, in particular cellulose ethers or esters.

The polysaccharide can also be chosen from polysaccharides containing galactomannans.

Polysaccharides containing galactomannans are heterogeneous polysaccharides consisting of galactose and mannose units. These nonionic polyglycosides can be extracted from the albumen of legume seeds, of which they constitute the reserve carbohydrate.

It more particularly concerns macromolecules consisting of a main chain of D-mannopyranose units bonded in β(1,4) fashion, carrying side branches consisting of a single D-galactopyranose unit bonded in α(1,6) fashion to the main chain. The different galactomannans differ, on the one hand, in the proportion of α-D-galactopyranose units present in the polymer and, on the other hand, in differences in terms of distribution of the galactose units along the mannose chain.

The mannose/galactose (M/G) ratio is of the order of 2 for guar gum, of 3 for tara gum and of 4 for locust bean gum.

Polysaccharides containing galactomannan can more particularly exhibit the following chemical structure:

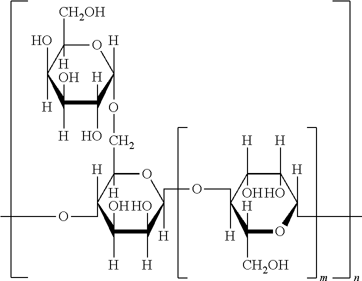

with, for example, m having the value 1 (guar gum), 2 (tara gum) or 3 (locust bean gum).

The polysaccharides containing galactomannan can be chosen in particular from guar gum, locust bean gum, tara gum and their derivatives.

The term “derivatives” is understood to mean more particularly chemically modified nonionic gums, or also cationic or anionic gums.

According to a particular embodiment, a lubricating composition according to the invention comprises at least one polysaccharide containing galactomannan of guar gum type. The expression “of guar gum type” is understood to denote guar gum and its derivatives, in particular chosen from chemically modified nonionic guar gums, cationic or anionic guar gums.

Guar gum is characterized by a mannose:galactose ratio of the order of 2:1. The galactose group is uniformly distributed along the mannose chain.

It is understood that a lubricating composition according to the invention can comprise a single polysaccharide containing galactomannan, in particular of guar gum type, or also a mixture of at least two distinct polysaccharides containing galactomannan, for example a mixture of at least two polysaccharides containing galactomannan which are chosen from guar gum and its derivatives.

The polysaccharides containing galactomannan of guar gum type can be unmodified or chemically modified nonionic guar gums.

The modified nonionic guar gums which can be used according to the invention can more particularly be guar gums modified with C₁-C₆ hydroxyalkyl groups, among which may be mentioned, by way of examples, the hydroxymethyl, hydroxyethyl, hydroxypropyl and hydroxybutyl groups. By way of example, a chemically modified nonionic guar gum employed in a lubricating composition according to the invention can be hydroxypropyl guar.

The polysaccharides containing galactomannan, for example of guar gum type, can also be cationic galactomannans, in particular exhibiting a cationic charge density of less than or equal to 1.5 meq/g and more particularly of between 0.1 and 1 meq/g. The charge density can be determined according to the Kjeldahl method. It generally corresponds to a pH of the order of 3 to 9. In general, a cationic polysaccharide containing galactomannan comprises cationic groups and/or groups which can be ionized to give cationic groups.

The preferred cationic groups are chosen from those comprising primary, secondary, tertiary and/or quaternary amine groups.

The cationic polysaccharides containing galactomannan generally have a weight-average molecular weight of between 500 and 5×10⁶ approximately and preferably of between 103 and 3×10⁶ approximately.

It can concern, for example, a polysaccharide containing galactomannan comprising cationic tri(C₁-C₄)alkylammonium groups. Preferably, from 2% to 30% by number of the hydroxyl functions of the polysaccharide containing galactomannan carry cationic trialkylammonium groups.

Mention may very particularly be made, among these trialkylammonium groups, of the trimethylammonium and triethylammonium groups.

More preferentially still, these groups represent from 5% to 20% by weight of the total weight of the modified polysaccharide containing galactomannan.

The polysaccharides containing galactomannan of guar gum type can thus be cationic guar gums, in particular comprising hydroxypropyltrimethylammonium groups. They can be obtained, for example, by reaction of guar gum with 2,3-epoxypropyltrimethylammonium chloride.

By way of example, a cationic guar gum employed in a lubricating composition according to the invention can be guar hydroxypropyltrimonium chloride.

The polysaccharides containing galactomannan, for example of guar gum type, can also be anionic galactomannans. In particular, it can concern polysaccharides containing galactomannan comprising groups derived from carboxylic acid, sulfonic acid, sulfenic acid, phosphoric acid, phosphonic acid or pyruvic acid. Preferably, the anionic group is a carboxylic acid group. The anionic group can also be provided in the form of an acid salt, in particular a sodium, calcium, lithium or potassium salt.

The polysaccharides containing galactomannan of guar gum type can thus be carboxymethylated guar gums, such as a carboxymethyl guar or a carboxymethyl hydroxypropyl guar.

By way of example, an anionic guar gum employed in a lubricating composition according to the invention can be carboxymethyl hydroxypropyl guar.

Preferably, said polysaccharide(s) containing galactomannan employed in a lubricating composition according to the invention are chosen from guar gum, guar gum derivatives and their mixtures, in particular from guar gum, hydroxypropyl guar, carboxymethyl hydroxypropyl guar, guar hydroxypropyltrimonium chloride and their mixtures.

According to a particular embodiment, a lubricating composition according to the invention employs, as polysaccharide containing galactomannan, at least hydroxypropyl guar.

An aqueous lubricating composition according to the invention comprises said polysaccharide(s) in a content of between 0.01% and 10% by weight, more preferentially between 0.1% and 5% by weight, more preferably still between 0.1% and 3.5% by weight, in particular between 0.2% and 1% by weight, with respect to the total weight of the composition.

### Alkoxylated Castor Oil

As indicated above, an aqueous lubricating composition according to the invention comprises from 0.1% to 10% by weight of at least one alkoxylated, in particular ethoxylated, castor oil.

It is understood that a lubricating composition according to the invention can comprise a single alkoxylated, in particular ethoxylated, castor oil or a mixture of at least two distinct particular alkoxylated castor oils, in particular as are described below.

Castor oil is composed of fatty acid, predominantly C₁₆ to C₁₈ fatty acid, triglycerides. More particularly, ricinolein, the triglyceride of ricinoleic acid (C₁₈ fatty acid), is the major constituent of castor oil.

An alkoxylated castor oil is formed of alkoxylated triglycerides.

Preferably, a lubricating composition according to the invention comprises a (C₁-C₄) alkoxylated, preferably ethoxylated, castor oil.

It can be obtained by alkoxylation of castor oil with an alkylene oxide, in particular a C₁ to C₄ alkylene oxide, or also by transesterification with a polyalkylene glycol, in particular a poly(C₁-C₄)alkylene glycol.

Preferably, a lubricating composition according to the invention employs an ethoxylated castor oil. It can be obtained by ethoxylation of castor oil with ethylene oxide or also by transesterification of castor oil with a polyethylene glycol.

According to a particular embodiment, a lubricating composition according to the invention employs an ethoxylated castor oil, obtained by reaction of castor oil with ethylene oxide, in a castor oil:ethylene oxide molar ratio of between 1:1 and 1:100.

An ethoxylated castor oil employed in a lubricating composition according to the invention can comprise in particular at least 20 oxyethylene groups, preferably from 35 to 45 oxyethylene groups.

Preferably, it concerns an ethoxylated castor oil obtained by reaction of castor oil with ethylene oxide, in a castor oil:ethylene oxide molar ratio of approximately 1:35, denoted “PEG-35-castor oil”.

As mentioned above, the alkoxylated, preferably ethoxylated, castor oil, in particular as described above, is employed in a proportion of 0.1% to 10% by weight, with respect to the total weight of the composition, in particular of 1% to 10% by weight and more particularly of 2% to 5% by weight, with respect to the total weight of the composition.

Phosphorus-Containing and/or Sulfur-Containing Compound

As indicated above, an aqueous lubricating composition according to the invention comprises from 0.1% to 10% by weight of at least one sulfur-containing and/or phosphorus-containing antiwear compound.

It more particularly concerns an organophosphorus- and/or organosulfur-containing, preferably organosulfur-containing, antiwear compound.

Within the meaning of the present invention, the term “phosphorus-containing compound” is understood to denote an antiwear additive comprising at least one phosphorus atom.

Within the meaning of the present invention, the term “sulfur-containing compound” is understood to denote an antiwear additive comprising at least one sulfur atom.

Within the meaning of the present invention, the term “phosphorus/sulfur-containing compound” is understood to denote an antiwear additive comprising at least one phosphorus atom and at least one sulfur atom.

Within the meaning of the present invention, the term “antiwear compound” is understood to denote a compound exhibiting antiwear properties which can in particular be evaluated by a 4-ball extreme-pressure test, in particular according to the standard ASTM D2783. Such compounds are well known to a person skilled in the art.

It is understood that an aqueous lubricating composition according to the invention can comprise a single sulfur- and/or phosphorus-containing antiwear compound or a mixture of at least two distinct sulfur- and/or phosphorus-containing antiwear compounds, in particular as defined below.

### Phosphorus-Containing Compounds

An aqueous lubricating composition according to the invention can comprise at least one phosphorus-containing compound. In particular, the phosphorus-containing compounds considered according to the invention do not contribute sulfur.

Said phosphorus-containing compound(s) are advantageously employed in a form which is soluble or emulsifiable in water, in particular in the form of ionic salts.

In particular, the phosphorus-containing compound can be chosen from amine phosphates; phosphates, such as phosphate esters, in particular alkyl, alkenyl or aryl phosphates; polyphosphates; phosphonates, such as phosphonate esters, in particular alkyl, alkenyl or aryl phosphonates; polyphosphonates; carbamyl phosphates; phosphinates; and their mixtures.

The phosphorus-containing compound(s) are preferably present in an aqueous lubricating composition according to the invention in the form of salts, in particular in the form of phosphate, phosphonate or phosphinate ions, neutralized by an appropriate counterion.

The salts can be alkali metal or alkaline earth metal, ammonium, alkanolamine, in particular C₂-C₈ alkanolamine, or alkaneamine, in particular C₂-C₈ alkanemine, salts of phosphate, of phosphonate or of phosphinate.

Examples of compounds very particularly suitable for the invention are phosphate esters, phosphonate esters and their salts, preferably phosphate esters and their salts.

The phosphate esters, also called phosphoric acid esters, can be obtained by reaction of at least one ethoxylated or nonethoxylated, linear or branched, alcohol, preferably of at least one alcohol comprising between 1 and 12 carbon atoms, more preferentially between 2 and 8 carbon atoms, with phosphorus pentoxide of formula P₂O₅ or with phosphoric acid.

Preferably, a phosphorus-containing compound employed in an aqueous composition according to the invention is chosen from salts of phosphate esters, in particular alkali metal salts of phosphate esters, in particular of C₁-C₈ alkyl or di(C₁-C₈)alkyl phosphate esters.

Such a compound can in particular be chosen from potassium butyl phosphate, potassium dibutyl phosphate and their mixtures.

### Sulfur-Containing Compounds

According to another particular embodiment, an aqueous lubricating composition according to the invention can comprise at least one sulfur-containing compound, in particular not contributing phosphorus.

The sulfur-containing antiwear compounds can be chosen in particular from polysulfides, in particular sulfur-containing olefins, sulfur-containing fatty acids and sulfur-containing fatty acid esters, preferably employed in their neutralized form, which can be emulsified in water.

Advantageously, an aqueous lubricating composition according to the invention comprises at least one organosulfur-containing compound of sulfur-containing fatty acid type, preferably in a neutralized form, in particular a form neutralized with inorganic basifying agents or alkanolamines.

The sulfur-containing fatty acids can comprise from 8 to 22 carbon atoms, preferably from 12 to 18 carbon atoms.

The amount of sulfur according to the standard ASTM D2622 contributed by said sulfur-containing fatty acid(s) can be of between 5% and 30% by weight, in particular between 10% and 20% by weight.

Preferably, the amount of active sulfur at 150° C. according to the standard ASTM D 1662 contributed by said sulfur-containing fatty acid(s) in the aqueous lubricating composition according to the invention is greater than or equal to 2% by weight, in particular of between 5% and 10% by weight, with respect to the total weight of the lubricating composition.

Within the meaning of the present invention, the term “active sulfur” means the sulfur which a chemical compound is capable of yielding or releasing when this compound is placed under the conditions of the standard ASTM D1662. The standard ASTM D-1662 defines an active sulfur content of a compound at a given temperature as a difference, expressed as percentage by weight, in sulfur content before and after reaction of a sample of this sulfur-containing compound with a given amount of copper over a fixed time.

The amount of active sulfur at 150° C. (standard ASTM D1662) in the aqueous lubricating composition of the invention can influence its extreme-pressure performance qualities. This amount of active sulfur at 150° C. (ASTM D1662) in the lubricating composition must not be too low, otherwise satisfactory extreme-pressure behavior cannot be obtained. It must not be too high, in order to avoid a risk of corrosion, in particular with respect to metals and metal alloys, in particular with respect to copper.

As mentioned above, said sulfur-containing fatty acid(s) are preferably employed in an aqueous lubricating composition according to the invention in their form neutralized with a basifying agent, such as sodium hydroxide, potassium hydroxide, or an alkanolamine, such as monoethanolamine, triethanolamine, monoisopropanolamine, diisopropanolamine and triisopropanolamine.

### Phosphorus/Sulfur-Containing Compounds

Examples of phosphorus/sulfur-containing compounds suitable for the invention are more particularly thiophosphates, in particular metal alkyl thiophosphates, thiophosphites, including thiophosphoric and thiophosphorous acids, esters of these acids, their salts, dithiophosphites and dithiophosphates.

Mention may be made, as examples of such compounds, of amine dithiophosphates, monobutyl thiophosphate, monooctyl thiophosphate, monolauryl thiophosphate, dibutyl thiophosphate, dilauryl thiophosphate, tributyl thiophosphate, trioctyl thiophosphate, triphenyl thiophosphate, trilauryl thiophosphate, monobutyl thiophosphite, monooctyl thiophosphite, monolauryl thiophosphite, dibutyl thiophosphite, dilauryl thiophosphite, tributyl thiophosphite, trioctyl thiophosphite, triphenyl thiophosphite, trilauryl thiophosphite and their salts.

Examples of salts of the esters of thiophosphoric acid and of thiophosphorous acid are those obtained by reaction with a nitrogenous compound, such as ammonia or an amine, or zinc oxide or zinc chloride.

Preferably, a lubricating composition according to the invention employs one or more sulfur- or phosphorus-containing, preferably sulfur-containing, antiwear compounds, in particular as defined above and more particularly chosen from sulfur-containing fatty acids comprising from 8 to 22 carbon atoms, preferably from 12 to 18 carbon atoms, preferably in a neutralized form, in particular a form neutralized with inorganic basifying agents or alkanolamines.

Said sulfur- and/or phosphorus-containing, preferably sulfur-containing, antiwear compound(s) are employed in an aqueous lubricating composition according to the invention in a proportion of 0.1% to 10% by weight, preferably of 0.1% to 5.0% by weight, more preferentially of 0.5% to 3.0% by weight, with respect to the total weight of the composition.

According to a particular embodiment, a lubricating composition according to the invention can comprise said sulfur- and/or phosphorus-containing, preferably sulfur-containing, antiwear compound(s) and one or more castor oils, preferably an ethoxylated castor oil, in an antiwear compound(s):castor oil(s) ratio by weight of between 1:1 and 10:1, in particular of approximately 1:1.

### Other Compounds

### Polyalkylene Glycol

As indicated above, an aqueous lubricating composition according to the invention preferably comprises, in addition, at least one polyalkylene glycol.

Polyalkylene glycols (denoted “PAGs”) are homo- or copolymers consisting of alkylene oxide units.

They are in particular chosen from water-soluble polyalkylene glycols.

The term “water-soluble” is understood to denote a polyalkylene glycol having a solubility in water of at least 10 g/l, preferably of at least 500 g/l, in water at ambient temperature (approximately 25° C.).

The polyalkylene glycols can be more particularly formed of C₁-C₄, preferably C₁-C₃, more particularly C₂-C₃, alkylene oxide units.

Advantageously, a polyalkylene glycol employed in an aqueous lubricating composition according to the invention comprises at least 50% by weight of propylene oxide and/or ethylene oxide units.

It can concern a copolymer, in particular a random copolymer, comprising ethylene oxide, propylene oxide and/or butylene oxide units. Preferably, it can concern an ethylene oxide/propylene oxide copolymer, in particular a random copolymer.

Preferably, a polyalkylene glycol employed in an aqueous lubricating composition according to the invention exhibit a number-average molar mass (Mn) of between 100 and 25 000 g·mol⁻¹, preferably between 5000 and 21 000 g·mol⁻¹.

The number-average molar mass can be measured by gel permeation chromatography (GPC).

Preferably, a polyalkylene glycol employed in an aqueous lubricating composition according to the invention exhibits a kinematic viscosity measured at 100° C. (KV100), according to the standard ASTM D445, of between 100 and 5000 mm²/s, in particular between 150 and 3000 mm²/s, for example between 1500 and 3000 mm²/s or between 100 and 250 mm²/s.

Preferably, a polyalkylene glycol employed in an aqueous lubricating composition according to the invention exhibits a kinematic viscosity measured at 40° C. (KV40), according to the standard ASTM D445, of between 500 and 30 000 mm²/s, more particularly between 1000 and 25 000 mm²/s, for example between 10 000 and 25 000 mm²/s or between 500 and 2500 mm²/s.

The flash point of a polyalkylene glycol employed in an aqueous lubricating composition according to the invention is preferably greater than or equal to 160° C., in particular greater than or equal to 220° C., for example of between 220° C. and 300° C. The flash point can be measured by the standard ISO 2592 or ASTM D92.

Preferably, a polyalkylene glycol employed in an aqueous lubricating composition according to the invention exhibits a viscosity index, measured according to the standard ASTM D2270, of between 100 and 800, preferably between 250 and 550.

Such polyalkylene glycols may be commercially available or synthesized according to methods known to a person skilled in the art. They can be obtained, for example, by polymerization or copolymerization of alkylene oxides having between 2 and 4 carbon atoms. An example of synthesis is, for example, described in detail in the document US2012/0108482, by reaction between one or more alcohols having between 2 and 12 carbon atoms, in particular polyols, such as diols, with alkylene oxides, in particular ethylene oxide, propylene oxide and/or butylene oxide. The alcohol can preferably be a diol, in particular 1,2-propanediol.

In particular, said polyalkylene glycol compound(s) can be employed in an aqueous lubricating composition according to the invention in a content of between 0.001% and 80% by weight, preferably between 0.1% and 15% by weight, more preferentially between 1% and 10% by weight, in particular between 2% and 5% by weight, with respect to the total weight of the composition.

### Additives

An aqueous lubricating composition according to the invention can additionally comprise various additives.

It is understood that said additive(s) are compatible with their employment in an aqueous medium. Advantageously, the additives are employed in a form which is soluble or emulsifiable in water, for example in the form of ionic liquids or salts.

Said additive(s) are of course chosen from the viewpoint of the application targeted for the aqueous lubricant.

Of course, a person skilled in the art will take care to choose the optional additives and/or their amounts in such a way that the advantageous properties of the aqueous lubricating composition according to the invention, in particular the advantageous effect of improvement in the tribological properties, in particular the extreme-pressure properties, and protection of the parts against wear, are not detrimentally affected by the envisaged addition.

Such additives can be more particularly chosen from antifoaming agents, biocides, pH regulators, corrosion inhibitors, antiwear and/or extreme-pressure additives other than the abovementioned sulfur- and/or phosphorus-containing compounds, sequestering agents, metal passivating agents, dyes, dispersants, emulsifying agents, wetting agents and their mixtures.

Advantageously, an aqueous lubricating composition according to the invention can comprise one or more additives chosen from antifoaming agents, biocides, pH regulators, corrosion inhibitors, sequestering agents, metal passivating agents, emulsifying agents and their mixtures.

An aqueous lubricating composition according to the invention can more particularly comprise from 1% to 50% by weight of additives, in particular from 5% to 40% by weight of additives, with respect to the total weight of the composition.

### Corrosion Inhibitor

An aqueous lubricating composition according to the invention can comprise at least one agent which inhibits corrosion. Corrosion inhibitors make it possible advantageously to reduce, indeed even to prevent, the corrosion of metal parts. The nature of said corrosion inhibitor(s) can be chosen from the viewpoint of the metal to be protected against corrosion, such as aluminum, steel, galvanized steel or yellow metals, for example copper or brass.

Mention may be made, among inorganic corrosion inhibitors, of sodium, potassium, calcium or magnesium nitrites, sulfites, silicates, borates or phosphates, alkali metal phosphates, or zinc, magnesium or nickel hydroxides, molybdates or sulfates.

Mention may be made, among organic corrosion inhibitors, of aliphatic monocarboxylic acids, in particular having from 4 to 15 carbon atoms, for example octanoic acid, aliphatic dicarboxylic acids having from 4 to 15 carbon atoms, for example decanedioic acid (sebacic acid), undecanedioic acid, dodecanedioic acid, isononanoic acid or their mixtures, polycarboxylic acids optionally neutralized with triethanolamine, such as 1,3,5-triazine-2,4,6-tri(6-aminocaproic acid), alkanoylamidocarboxylic acids, in particular isononanoylamidocaproic acid, 6-[[(4-methylphenyl)sulfonyl]amino]hexanoic acid and their mixtures. Borated amides, products of the reaction of amines or aminoalcohols with boric acid, can also be used.

An aqueous lubricating composition according to the invention can in particular comprise from 0.01% to 15% by weight of corrosion inhibitor(s), preferably from 1.0% to 13% by weight, with respect to the total weight of the composition.

### Antifoaming Agent

An aqueous lubricating composition according to the invention can comprise at least one antifoaming additive. Antifoaming agents prevent foaming of the lubricating fluid.

It can concern, for example, an antifoaming agent based on polysiloxanes or on acrylate polymers. Preferably, the antifoaming agent is chosen from three-dimensional siloxanes.

Also, the antifoaming agents can be polar polymers, such as polymethylsiloxanes or polyacrylates.

In particular, an aqueous lubricating composition according to the invention can comprise from 0.001% to 3.0% by weight of antifoaming additive(s), preferably from 0.005% to 1.5% by weight, with respect to the total weight of the lubricating composition.

### pH Regulator

An aqueous lubricating composition according to the invention can comprise at least one additive which is a pH regulator, in particular an alkaline buffer. The pH regulator makes it possible to maintain the desired pH of the lubricating composition, in particular in order to preserve an alkaline pH, advantageously of between 8 and 11, so as in particular to prevent corrosion of metal surfaces.

The pH regulator can be chosen from the family of the amines, in particular alkanolamines and aminoalcohols.

It can in particular concern an additive which is a pH regulator chosen from ethanolamines, such as monoethanolamine (MEA), diethanolamine (DEA), triethanolamine (TEA) or diglycolamine (DGA), isopropanolamines, such as monoisopropanolamine (MIPA), diisopropanolamine (DIPA) and triisopropanolamine (TIPA), ethyleneamines, such as ethylenediamine (EDA), diethylenetriamine (DETA), triethylenetetramine (TETA) and tetraethylenepentamine (TEPA), alkanolamines, such as methyldiethanolamine (MDEA), cyclamines, such as cyclohexylamine, 2-amino-2-ethyl-1,3-propanediol, 2-amino-2-methyl-1-propanol and their mixtures.

An aqueous lubricating composition according to the invention can in particular comprise from 1% to 25% by weight of additive(s) which is (are) pH regulator(s), preferably from 5% to 20% by weight, with respect to the total weight of the composition.

### Metal Passivating Agents

An aqueous lubricating composition according to the invention can comprise at least one metal passivating agent. Metal passivating agents make it possible to protect metal parts by promoting the formation of metal oxide at their surface.

The metal passivating agents can, for example, be chosen from triazole derivatives, such as tetrahydrobenzotriazole (THBTZ), tolyltriazole (TTZ), benzotriazole (BTZ), amines substituted by a triazole group, such as N,N-bis(2-ethylhexyl)-1,2,4-triazol-1-ylmethanamine, N′-bis(2-ethylhexyl)-4-methyl-1H-benzotriazol-1-methylamine, N,N-bis(heptyl)-ar-methyl-1H-benzotriazole-1-methanamine, N,N-bis(nonyl)-ar-methyl-1H-benzotriazole-1-methanamine, N,N-bis(decyl)-ar-methyl-1H-benzotriazole-1-methanamine, N,N-bis(undecyl)-ar-methyl-1H-benzotriazole-1-methanamine, N,N-bis(dodecyl)-ar-methyl-1H-benzotriazole-1-methanamine, N,N-bis(2-ethylhexyl)-ar-methyl-1H-benzotriazole-1-methanamine, 1,2,4-triazoles, benzimidazoles, 2-alkyldithiobenzimidazoles, 2-alkyldithiobenzothiazoles, 2-(N,N-dialkyldithiocarbamoyl)benzothiazoles, 2,5-bis(alkyldithio)-1,3,4-thiadiazoles, such as 2,5-bis(tert-octyldithio)-1,3,4-thiadiazole, 2,5-bis(tert-nonyldithio)-1,3,4-thiadiazole, 2,5-bis(tert-decyldithio)-1,3,4-thiadiazole, 2,5-bis(tert-undecyldithio)-1,3,4-thiadiazole, 2,5-bis(tert-dodecyldithio)-1,3,4-thiadiazole, 2,5-bis(tert-tridecyldithio)-1,3,4-thiadiazole, 2,5-bis(tert-tetradecyldithio)-1,3,4-thiadiazole, 2,5-bis(tert-pentadecyldithio)-1,3,4-thiadiazole, 2,5-bis(tert-hexadecyldithio)-1,3,4-thiadiazole, 2,5-bis(tert-heptadecyldithio)-1,3,4-thiadiazole, 2,5-bis(tert-octadecyldithio)-1,3,4-thiadiazole, 2,5-bis(tert-nonadecyldithio)-1,3,4-thiadiazole, 2,5-bis(tert-eicosyldithio)-1,3,4-thiadiazole, 2,5-bis(N,N-dialkyldithiocarbamoyl)-1,3,4-thiadiazoles, 2-alkyldithio-5-mercaptothiadiazoles and their mixtures.

Preferably, the metal passivating agents are chosen from tetrahydrobenzotriazole (THBTZ), tolyltriazole (TTZ), benzotriazole (BTZ) and their salts, taken alone or as mixtures.

An aqueous lubricating composition according to the invention can in particular comprise from 0.01% to 2.0% by weight of metal passivating agent(s), preferably from 0.1% to 1.0% by weight, more preferentially from 0.2% to 0.8% by weight, with respect to the total weight of the composition.

### Dyes

An aqueous lubricating composition according to the invention can comprise one or more dyes. The dyes can be natural or synthetic, generally organic.

The dyes which can be employed in an aqueous lubricating composition can be more particularly chosen from natural or synthetic water-soluble dyes, for example the dyes FDC Red 4, DC Red 6, DC Red 22, DC Red 28, DC Red 30, DC Red 33, DC Orange 4, DC Yellow 5, DC Yellow 6, DC Yellow 8, FDC Green 3, DC Green 5, FDC Blue 1, betanin (beet), carmine, a chlorophyllin, methylene blue, anthocyanins (enocyanin, black carrot and hibiscus), caramel and riboflavin.

An aqueous lubricating composition according to the invention can comprise between 0.01% and 2.0% by weight of dye(s), preferably between 0.01% and 1.5% by weight, more preferentially between 0.02% and 1.0% by weight, with respect to the total weight of the composition.

### Emulsifying Agents

An aqueous lubricating composition according to the invention can comprise one or more emulsifying agents, also called emulsifiers. Their function is to generate emulsions which are stable in water.

The emulsifying agents can more particularly be nonionic, such as, for example, ethoxylated fatty alcohols, ethoxylated fatty acids, compounds resulting from the reaction between propylene oxide, ethylenediamine and optionally ethylene oxide, ethoxylated fatty amides; anionic, for example KOH or NaOH soaps; sulfonates; cationic, such as quaternary ammonium compounds; or also water-soluble or water-emulsifiable carboxylic acid esters.

In particular, an aqueous lubricating composition according to the invention can comprise from 0.01% to 10% by weight of emulsifying agent(s), preferably from 0.1% to 5.0% by weight, with respect to the total weight of the lubricating composition.

### Sequestering Agents

An aqueous lubricating composition according to the invention can comprise at least one sequestering agent. Sequestering agents, also called chelating agents, make it possible to limit the encrustation of metal ions in the composition.

Mention may be made, as examples of sequestering agents, of those derived from phosphonic acids and phosphonates, such as diethylenetriaminepentamethylenephosphonic acid (DTPMPA), aminotri(methylenephosphonic acid) (ATMP), hydroxyethanediphosphonic acid (HEDP), 1-hydroxyethylidene-1,1-diphosphonate, 2-hydroxyethylaminodi(methylenephosphonic acid) (HEAMBP), diethylenetriaminepenta(methylenephosphonic acid) (DTMP), multifunctional organic acids and hydroxylated acids, such as ethylenediaminetetraacetic acid (EDTA), pteroyl-L-glutamic acid (PGLU), organic polyacids, such as maleic acid and polyaspartic acid, and carbohydrates, such as inulin, carboxymethyl inulin and carboxymethyl chitosan.

An aqueous lubricating composition according to the invention can comprise from 0.001% to 2.0% by weight of sequestering agent(s), preferably from 0.01% to 1.0% by weight, with respect to the total weight of the composition.

### Biocides

An aqueous lubricating composition according to the invention can comprise at least one biocidal agent having a bactericidal and/or fungicidal action. The biocides can be used to improve the biological stability of the composition by limiting the proliferation of bacteria, fungi and yeasts in the lubricating fluid.

Such biocides can be chosen from parabens, aldehydes, reactive acetylacetone compounds, isothiazolinones, phenolic compounds, acid salts, halogenated compounds, quaternary ammoniums, certain alcohols and their mixtures.

Preferably, the biocides can be chosen from optionally substituted benzisothiazolinones (BITs), such as N-butyl-1,2-benzisothiazolin-3-one, methylisothiazolinones (MITs), mixtures of methylisothiazolinone and of chloromethylisothiazolinone (MIT/CMIT), ortho-phenylphenol (OPP) or its sodium salt, 3-iodo-2-propynyl butylcarbamate (IPBC), chloro-cresol and N,N-methylenebismorpholine (MBM); sorbic acid; preferably from ortho-phenylphenol (OPP) or its sodium salt, 3-iodo-2-propynyl butylcarbamate, chloro-cresol, benzisothiazolinones and N,N-methylenebismorpholine.

An aqueous lubricating composition according to the invention can in particular comprise between 0.01% and 10% by weight of biocide(s), preferably between 0.1% and 5.0% by weight, with respect to the total weight of the composition.

According to a particular embodiment, an aqueous lubricating composition according to the invention comprises:
at least 50% by weight of water, preferably of osmosed water;
from 0.01% to 10% by weight of at least one polysaccharide, especially as defined above, in particular a polysaccharide containing galactomannan and more particularly of guar gum type;
from 0.1% to 10% by weight of at least one alkoxylated, in particular ethoxylated, castor oil;
from 0.1% to 10% by weight of at least one phosphorus- and/or sulfur-containing, in particular sulfur-containing, antiwear compound; and
optionally from 1% to 50% by weight, in particular from 5% to 40% by weight, of one or more additives chosen from antifoaming agents, biocides, pH regulators, corrosion inhibitors, sequestering agents, metal passivating agents, emulsifying agents and their mixtures, the contents being expressed with respect to the total weight of the lubricating composition.

Preferably, an aqueous lubricating composition according to the invention comprises:
at least 50% by weight of water, preferably of osmosed water;
from 0.01% to 10% by weight of at least one polysaccharide, especially as defined above, in particular a polysaccharide containing galactomannan and more particularly of guar gum type;
from 0.1% to 10% by weight of at least one alkoxylated, in particular ethoxylated, castor oil;
from 0.1% to 10% by weight of at least one phosphorus- and/or sulfur-containing, in particular sulfur-containing, antiwear compound;
from 0.001% to 30% by weight, preferably from 0.1% to 15% by weight, of at least one polyalkylene glycol, in particular as defined above; and
optionally from 1% to 50% by weight, in particular from 5% to 40% by weight, of one or more additives chosen from antifoaming agents, biocides, pH regulators, corrosion inhibitors, sequestering agents, metal passivating agents, emulsifying agents and their mixtures, the contents being expressed with respect to the total weight of the lubricating composition.

In particular, an aqueous lubricating composition according to the invention can consist of:
from 0.01% to 10% by weight of at least one polysaccharide, especially as defined above, in particular a polysaccharide containing galactomannan and more particularly of guar gum type;
from 0.1% to 10% by weight of at least one alkoxylated, in particular ethoxylated, castor oil;
from 0.1% to 10% by weight of at least one phosphorus- and/or sulfur-containing, in particular sulfur-containing, antiwear compound;
from 0.001% to 30% by weight of at least one polyalkylene glycol, preferably from 0.1% to 15% by weight, in particular as defined above; and
optionally from 1% to 50% by weight, in particular from 5% to 40% by weight, of one or more additives chosen from antifoaming agents, biocides, pH regulators, corrosion inhibitors, sequestering agents, metal passivating agents, emulsifying agents and their mixtures,
   the contents being expressed with respect to the total weight of the lubricating composition, and
   the remainder consisting of water, preferably of osmosed water.

According to the invention, the particular, advantageous or preferred characteristics of the composition according to the invention make it possible to define uses according to the invention which are also particular, advantageous or preferred.

The invention will now be described by means of the following examples given, of course, by way of nonlimiting illustration of the invention.

### EXAMPLE

### Measurement of Tribological Properties

The extreme-pressure and antiwear properties of the lubricating compositions are evaluated by the 4-ball test according to the standard ASTM D2783 adapted with the following parameters:
speed close to 1500 revolutions/minute,
ambient temperature, i.e. approximately 20° C.,
loading time of 1 minute.

The extreme-pressure measurement is carried out by rotation of a stainless steel ball on three balls, also made of stainless steel, which are kept stationary, the four balls being completely covered with a film of lubricant. A load is applied to the balls and gradually increased (every minute according to the above parameters) until the balls weld together. The balls are changed before each increase in the load.

The extreme-pressure power corresponds to the value of the load from which the four balls weld together, preventing the rotation of the upper ball on the other three. The greater the load, the greater the extreme-pressure power.

This method also makes it possible to evaluate the antiwear properties of a lubricating composition. During the gradual increase in load, it is possible to determine, at each stationary phase, the wear diameter on the three balls. The smaller the wear diameter, the more effective the lubricant is in preventing wear (or seizure) of the parts.

The wear diameter values provided in the examples which follow are those obtained for the load value preceding the welding of the balls.

It is common practice to dilute the compositions before carrying out the load tests, and the dilution ratio is thus specified in the results below.

### Example 1: Preparation of the Lubricating Compositions

An aqueous lubricating composition according to the invention (I1) and three comparative aqueous lubricating compositions, C1 not comprising phosphorus- and/or sulfur-containing compound, C2 not comprising alkoxylated castor oil and C3 not comprising alkoxylated castor oil or phosphorus- and/or sulfur-containing compound, were formulated according to the protocol below, in the percentages by weight shown in the following table 1.

The formulation protocol is as follows:

The polysaccharide and optionally the alkoxylated castor oil are dissolved in osmosed water. The solution is stirred at ambient temperature (close to 20° C.) for 30 minutes.

Then, the other components are added as follows: introduction of the additive(s) which is (are) regulator(s) of pH, then of the additive(s) which is (are) inhibitor(s) of corrosion while heating the mixture to a temperature of 40° C. to 50° C. The solution is stirred using a magnetic bar for a period of time ranging from 1 hour to 1 hour 30 minutes. The following compounds are subsequently added, sequentially every 5 minutes, in the following order and still with stirring: passivator(s), sequestering agent(s), PAG, the antiwear additive(s), then optionally wetting agent(s), antifoaming agent(s) and biocide(s).

Finally, a final stirring is carried out for a period of time of 1 hour.

TABLE 1

| | I1 according | C1 outside | C2 outside | C3 outside |
|---|---|---|---|---|
| | to the | the | the | the |
| Composition | invention | invention | invention | invention |
| Osmosed water [%] | 63.01 | 65.01 | 65.01 | 67.01 |
| Polysaccharide 1 [%] | 0.40 | 0.40 | 0.40 | 0.40 |
| (Hydroxyethyl | | | | |
| cellulose) | | | | |
| Ethoxylated castor oil | 2 | 2 | — | — |
| [%] | | | | |
| (PEG-35 castor oil) | | | | |
| Sulfur-containing | 2 | — | 2 | — |
| antiwear compound | | | | |
| [%] | | | | |
| (Sulfur-containing | | | | |
| fatty acid) | | | | |
| Additive(s)⁽¹⁾ | 32.59 | 32.59 | 32.59 | 32.59 |

⁽¹⁾The additive(s) are chosen from corrosion inhibitors, passivators, sequestering agents, pH regulators, antifoaming agents and biocides.

### Example 2: Characterization of the Composition According to the Invention and of the Comparative Compositions

The tribological properties were measured for each composition, as described in detail in the protocol above.

The results are compiled in table 2 below.

TABLE 2

| | Dilution ratio | Welding load | Wear diameter |
|---|---|---|---|
| Composition | [%] | [kg] | [mm] |
| I1 (invention) | 12 | 260 | 1.5-1.6 |
| C1 (comparative) | 12 | 220 | 1.6-1.7 |
| C2 (comparative) | 12 | 200 | 1.5-1.6 |
| C3 (comparative) | 12 | 180 | 1.7-1.8 |

The composition I1 according to the invention exhibits a load at welding which is significantly greater than that obtained for the comparative compositions C1 to C3 and an equivalent, indeed even lower, wear diameter.

Thus, the lubricating compositions in accordance with the invention, incorporating a combination of at least one phosphorus- and/or sulfur-containing antiwear compound and of an alkoxylated, in particular ethoxylated, castor oil, exhibit significantly improved extreme-pressure properties, compared with compositions not comprising one or the other of these compounds.

### Example 3: Preparation of the Lubricating Compositions

An aqueous lubricating composition according to the invention (I2) and three comparative aqueous lubricating compositions, C4 not comprising phosphorus- and/or sulfur-containing compound, C5 not comprising alkoxylated castor oil and C6 not comprising alkoxylated castor oil or phosphorus- and/or sulfur-containing compound, were formulated according to the same formulation protocol as described in example 1, with the percentages by weight shown in the following table 3.

TABLE 3

| | I2 according | C4 outside | C5 outside | C6 outside |
|---|---|---|---|---|
| | to the | the | the | the |
| Composition | invention | invention | invention | invention |
| Osmosed water [%] | 63.61 | 65.61 | 65.61 | 67.61 |
| Polysaccharide 2 [%] | 0.40 | 0.40 | 0.40 | 0.40 |
| (Hydroxypropyl guar) | | | | |
| Ethoxylated castor oil | 2 | 2 | — | — |
| [%] | | | | |
| (PEG-35 castor oil) | | | | |
| Sulfur-containing | 2 | — | 2 | — |
| compound [%] | | | | |
| (Sulfur-containing | | | | |
| fatty acid) | | | | |
| Additive(s)⁽¹⁾ | 31.99 | 31.99 | 31.99 | 31.99 |

⁽¹⁾The additive(s) are chosen from corrosion inhibitors, passivators, sequestering agents, pH regulators, antifoaming agents and biocides.

### Example 4: Characterization of the Composition According to the Invention and of the Comparative Compositions

The tribological properties were measured for each composition, as described in detail in the protocol above.

The results are compiled in table 4 below.

TABLE 4

| | Dilution ratio | Welding load | Wear diameter |
|---|---|---|---|
| Composition | [%] | [kg] | [mm] |
| I2 (invention) | 12 | 220 | 1.4-1.5 |
| C4 (comparative) | 12 | 180 | 1.7-1.8 |
| C5 (comparative) | 12 | 220 | 1.6-1.7 |
| C6 (comparative) | 12 | 180 | 1.6-1.7 |

The composition 12 according to the invention exhibits a load at welding which is equivalent to, indeed even greater than, those obtained for the comparative compositions C4 to C6 and a lower wear diameter under extreme-pressure conditions.

Thus, the lubricating compositions in accordance with the invention, incorporating a combination of at least one phosphorus- and/or sulfur-containing antiwear compound and of an alkoxylated, in particular ethoxylated, castor oil, exhibit significantly improved extreme-pressure properties, compared with compositions not comprising one or the other of these compounds.

1-12. (canceled)

13. An aqueous lubricant composition for metalworking comprising, based on a total weight of the composition:
water;
from 0.01% to 10% by weight of at least one polysaccharide;
from 0.1% to 10% by weight of at least one alkoxylated castor oil; and
from 0.1% to 10% by weight of at least one sulfur-containing and/or phosphorus-containing antiwear compound.

14. The aqueous lubricant composition of claim 13, comprising from 50% to 90% by weight of osmosed water.

15. The aqueous lubricant composition of claim 13, comprising from 60% to 75% by weight of osmosed water.

16. The aqueous lubricant composition of claim 13, wherein the at least one alkoxylated castor oil comprises an ethoxylated castor oil obtained by reacting castor oil and ethylene oxide, at a castor oil:ethylene oxide molar ratio of from 1:1 to 1:100.

17. The aqueous lubricant composition of claim 13, wherein the at least one alkoxylated castor oil comprises an ethoxylated castor oil obtained by reacting castor oil and ethylene oxide, at a castor oil:ethylene oxide molar ratio of 1:35.

18. The aqueous lubricant composition of claim 13, comprising from 1% to 10% by weight of the at least one alkoxylated castor oil.

19. The aqueous lubricant composition of claim 13, comprising from 2% to 5% by weight of the at least one alkoxylated castor oil.

20. The aqueous lubricant composition of claim 13, comprising from 0.1% to 5% by weight of the at least one polysaccharide

21. The aqueous lubricant composition of claim 13, comprising from 0.2% to 1% by weight of the at least one polysaccharide.

22. The aqueous lubricant composition of claim 13, wherein the at least one sulfur-containing and/or phosphorus-containing antiwear compound is chosen from organosulfur compounds of sulfur-containing fatty acids comprising from 8 to 22 carbon atoms.

23. The aqueous lubricant composition of claim 22, wherein the organosulfur compounds of sulfur-containing fatty acids comprise from 12 to 18 carbon atoms and are neutralized with inorganic basifying agents or alkanolamines.

24. The aqueous lubricant composition of claim 13, comprising from 0.1% to 5% by weight of the at least one phosphorus-containing and/or sulfur-containing antiwear compound.

25. The aqueous lubricant composition of claim 13, comprising from 0.5% to 3.0% by weight of at least one sulfur-containing antiwear compound.

26. The aqueous lubricant composition of claim 13, further comprising from 0.001% to 80% by weight of at least one polyalkylene glycol.

27. The aqueous lubricant composition of claim 26, wherein the at least one polyalkylene glycol comprises ethylene oxide, propylene oxide, and/or butylene oxide monomers.

28. The aqueous lubricant composition of claim 26, comprising from 2% to 5% by weight of the at least one polyalkylene glycol.

29. The aqueous lubricant composition of claim 13, further comprising at least one additive chosen from antifoaming agents, biocides, pH regulators, corrosion inhibitors, sequestering agents, metal passivating agents, emulsifying agents, or mixtures thereof.

30. A method of forming a metal part, comprising:
applying an aqueous lubricant composition to a metal workpiece and/or a machining tool; and
machining the metal workpiece using machining apparatus to form a metal part, such that the aqueous lubricant composition reduces friction during the machining,
wherein the aqueous lubricant composition comprises, based on a total weight of the composition:
water;
from 0.01% to 10% by weight of at least one polysaccharide;
from 0.1% to 10% by weight of at least one alkoxylated castor oil; and
from 0.1% to 10% by weight of at least one sulfur-containing and/or phosphorus-containing antiwear compound.

31. The method of claim 30, wherein the aqueous lubricant composition comprises:
from 60% to 75% by weight osmosed water;
from 2% to 5% by weight of at least one ethoxylated castor oil;
from 0.5% to 3.0% by weight of at least one sulfur-containing antiwear compound;
from 0.2% to 1% by weight of at least one polysaccharide; and
from 2% to 5% by weight of at least one polyalkylene glycol.
